(19) United States
(12) Patent Application Publication
(10) Pub. No.: US 2010/0298959 A1
(43) Pub. Date: Nov. 25, 2010

(54) SPEECH REPRODUCING METHOD, SPEECH REPRODUCING DEVICE, AND COMPUTER PROGRAM

(75) Inventor: Hiroshi Sekiguchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: VOXMOL LLC, Cheyenne, WY (US)

(21) Appl. No.: 12/673,563

(22) PCT Filed: Jul. 29, 2008
(86) PCT No.: PCT/JP2008/063581

§ 371 Date: Feb. 15, 2010

(30) Foreign Application Priority Data
Aug. 21, 2007 (JP) 2007-214773

(51) Int. Cl. G06F 17/00

(52) U.S. Cl. 700/94

(57) ABSTRACT

This invention concerns a voice reproducing apparatus enabling itself to reproduce voice information in units of a vocal chunk while extracting the boundary position of vocal chunks. The apparatus comprises a vocal chunk extraction block (802) for storing address identification information representing the boundary addresses while extracting the boundary address of two of more vocal chunks and a reproducing block (803) for reproducing audio data series (801) of each vocal chunk from a specified reproduction starting point while specifying a starting point of audio data series (801) according to the stored address identification information. Especially, the vocal chunk extracting block (802) extracts a small amplitude zone included in an audio data series (801), selects a small amplitude zone sandwiched between two vocal chunks out of the extracted small amplitude zones, and specifies the boundary address of the two vocal chunks in the selected small amplitude zone as an address identification information.

### TECHNICAL FIELD

This invention relates to a voice reproduction method to reproduce digital audio data series including at least a voice data series, a voice reproduction device, a computer program such an audio player application or the like which executes the voice reproduction method on a computer, and a distribution system to distribute a digital audio data series through either wireless or wired transmission line.

### BACKGROUND ART

The most popular format to store sound information is a format which was developed for music. Accordingly, a music format which is used on a music media is used for a digital audio data series as well even though it contains mainly a voice data series. For example, a music format is diverted when such an data series is recorded as a digital audio data series for listening study of foreign language, a digital audio data series for declamation of novel or poem and a voice media for the visually disabled.

On the other hand, several dedicated reproducers and its information recording medium which are convenient for listening to a voice data series have been developed before. However, those reproducers all have been popularized incomparably less than players and media for music, and such situation is still same now When we thought about reasons why those have not been popularized, we found one reason. That is, a voice data series was recorded with a specially dedicated format. One of voice information recording media and its reproducing systems that made higher performance with dedicated format is disclosed in the following Patent Document 1.

### CITATION LIST

### Patent Document

Patent document 1: Japanese Patent No. 2581700

### SUMMARY OF INVENTION

### Problems that the Invention is to Solve

Since it is impossible to make convenient function for reproducing a voice data series as far as only the conventional technology is used, there is no choice except using the special recording format dedicated for voice data. On the other hand, professional editors in contents providers would not like to use dedicated format. The reason is that reproducing machines for unique media having such a dedicated format are not popular in the market. Consequently, it is an actual condition that only manufacturers of such high performance players or their related companies supply the contents for that players. Because of this reason, titles number or their kinds are extremely few. In fact, users population does not increase, thus the players do not get popular. Since the players do not get popular, contents providers do not want to use such players. Then, this negative spiral is repeated. All of the countries in the world have same situation in this issue.

When we observe the history of recording technology and the media for a voice data series, we found there have been several trials or challenges to improve the inconvenience of music player even using dedicated format, but those trials failed to be popular in the market. This history of challengers shows an evidence proving that many listeners feel it inconvenient to listen voice with an ordinary music player.

Accordingly, the inventor analyzed in detail what is inconvenient when a listener listens to voice information using a music player and he found the following problems. That is, it frequently happens for a listener to want to listen repeatedly a same sentence or a phrase while people have no complain to listen constantly in case of music. This is apparent if we imagine a scene where we are doing listening comprehension study of foreign language. Namely, students frequently face a scene where they want to go backward to a past portion in a media to listen again. This is not only in case of foreign language study but also it happens as well in case of listening in their mother tongue when they fail to hear some part even though the frequency is low.

However, when using a digital music player, if a listener try to move a play-back point backwardly, the play-back point returns at once to extreme beginning position of the contents in most players. There are audio devices with analog tape or the devices particularly with the function to move the play-back position little by little, but it is almost impossible to stop at the exact position that a listener want to stop. Even if such a device is acceptable, it is limited to listen to music. Because, a user listening to music hardly wants move backwardly the play-back position little by little.

And, if a listener uses a music player for study, the player goes advance forwardly regardless of whether or not he can catch the pronunciation. When listening foreign language contents, once he pays his attention to the area where he missed to catch, it gets more difficult for him to catch subsequent part. If he wants to listen again to a little previous area, the conventional player can not stop at the exact position where he wants to stop at as mentioned above, thus he is irritated more. In the end, he has voice sound from a player go in one ear to the other ear. However, it is obvious that improvement of listening ability is so slow by only making it pass through listener's ears. In the market there are many contents providers who advertise that you can improve listening ability only with making it pass through your ears. But, none of professional people approves it.

This invention was made to solve the above-mentioned problem. The purpose is to provide people with a way to extract the boundaries of vocal chunks contained in the digital audio information stream containing at least voice information stream, the way to make easy listening voice reproduction, voice reproduction device, computer program to execute reproduction method, data storage media storing such computer program and information distributing system which distributes a data series in parallel with a digital audio information steam to be reproduced enabling the system to reproduce the voice stream with a unit of voice chunk.

### Means for Solving the Problems

It has been believed that the voice information stored with music format is stored continuously without discontinuity like the case of music. However, the inventor observed carefully voice information stream and discovered that there were a sequence of “Chunk of Pronunciation” in time series like skewered dumpling even though it looked like continuous series of voice data without discontinuity. And, the inventor discovered that “Chunk of Pronunciation” can be used as the means for solving the problem.

In this specification each chunk of pronunciation like a skewered dumpling is called “vocal chunk”. The discovery of vocal chunk is similar to the discovery of gravitation because no one had noticed it until Newton noticed. The name of gravitation was born at that time. Vocal chunk is named at this discovery and this name is used commonly from now to future.

This invention is based on the concept of vocal chunk which is newly discovered, thus more detailed explanation is added as follows. In the field of Phonetics there have been a unit like Phonogram or Syllable but vocal chunk is different from those and a new concept which has not existed before.

A human produces a sound expelling air accumulated in the lung. That is, one unit of voice produced at one expelling time is correspondent to vocal chunk. Accordingly, it is very rare that vocal chunk over 10 seconds long appears, most of them are around 5 seconds long or less. And, a human usually tries to put the meaning together until one expelling breath is over. Or, a human stops producing a sound in a short period of time when he/she reach the point where the meaning of his/her voice is put together somewhat even though he/she does not have to inhale air because air still remains, or he/she tries to inhale more at that occasion. Usually, a human conducts such a action unconsciously. It means vocal chunk is produced naturally based on such a action of producing a human voice.

Additionally, vocal chunk exists not only in a particular language but also in all of the languages of any ethnic group. Because, vocal chunk is based on physiological phenomenon when a human produces a sound as mentioned above.

And, in a song being a kind of voice, there is a measure as a unit allaying in time series. Most of these cases it also delimits the voice at the pronunciation node. However, a measure has an integral multiple time of music beat thus it has almost constant interval. On the other hand, vocal chunk does not have constant cycle, this is a difference from a measure. There is vocal chunk to say only short one word, “Yes”, and it is not frequent but there is a long vocal chunk like talking fast and furious for almost 10 seconds without breath. Most of them, however, are about 5 seconds long.

Next, vocal chunk is explained with figures. Since voice contains audio waves whose frequency range is approximately 100 Hz to 4000 Hz, it is difficult to draw all waves with each voltage up and down. So, FIG. 1 shows the envelop curve of voice signal which is made by digital audio data series. In FIG. 1 its abscissa shows time decay and the longitudinal axis shows the value of signal's amplitude. The signal waveform varies almost symmetrically to plus and minus direction from the center of zero level. 200 in Figure shows zero level. 110 is the waveform and 100 is the envelop of the waveform. And, arrows A1 and B1 in FIG. 1 show small amplitude zones which appear in spots.

FIG. 1 shows the signal waves of digital audio data series of only voice signal with no sound in its background, but in fact, an audio data series unusually includes not only voice but also acoustic noise or music in its background. In such case, the amplitude level at small amplitude zones A2 and B2 do not become zero. Consequently, the data series which this invention targets contains not only “a voice data series with only a pure voice information” but also “a digital audio data series including at least a voice data series”.

The inventor found a way to resolve the problem mentioned in Paragraph [0004] by reproducing with managing vocal chunk. Because, a speaker unconsciously tries to sum up the meaning during his/her speech in a unit of vocal chunk, thus vocal chunk is an appropriate unit of length for a listener to catch the meaning. Therefore, a method that reproduction can automatically stops in a unit of vocal chunk and play-back position moves backward in a unit of vocal chunk can solve the above-mentioned problem to be solved because those play-back functions fit the listener's feeling.

And, the inventor has an inspiration about the method to extract vocal chunk from the continuous digital audio data series including voice data series. It is a mean to use the short time span with weak voice strength which comes up in between the current vocal chunk and the next one. For instance, the arrowhead A1 and B1 in FIG. 1 or A2 and B2 in FIG. 2 show small amplitude area. However, all small amplitude area should not be specified as Pronunciation Pause Zone because consonants in syllables usually have small amplitude signals. For instance, when FIG. 1 and FIG. 2 are referred, arrowheads A1 and A2 are the small amplitude area which appears among syllables and arrowheads B1 and B2 are the small amplitude area which appears in between vocal chunks. Those phenomena are frequently observed. Namely, it should be distinguished in which it exists, in a syllable area or in between two vocal chunks.

In order to extract pronunciation pause zone between a vocal chunk and the next vocal chunk, a small amplitude zone is extracted first as the candidate of pronunciation pause zone. Then, as in FIG. 3, it creates the amplitude information (which is a physical value data series to be judged for intensity using threshold) of a digital audio data series which shows reproduced waveform of the digital audio data series. Additionally, it is possible to generate the threshold from this amplitude data series itself as a physical value data series converted from such a digital audio data series. The physical value data series as the result converted from a digital audio data series is not limited to be one kind but is good enough as well to be, for instance, plural kinds physical value data series having different time resolution. In this case, a first physical value data series (time resolution pitch of which is relatively longer) selected from plural kinds of physical value data series converted is used for generating a threshold, while a second physical value data series (the time resolution pitch of which is set to be shorter than that for the first physical value data series) is used for judgment of a boundary of a small amplitude zone. Naturally, when a digital audio data series is converted to one kind of physical value data series, the relevant first and second physical value data series are identical. In case that threshold generation and judgment of boundary are done using two kinds of physical value data series, it is supposed that it can make more delicate judgment than using one kind of physical value data series.

The envelop of amplitude information generated as above is correspondent to the upper envelop of the signal waveform shown in FIG. 1. If there is no noise in the background like shown in FIG. 1, it is possible to detect small amplitude zone as shown with arrowhead B1 and B2 in FIG. 3 making threshold level a little higher than zero level and detecting the zone whose amplitude is lower than the said threshold. And, amplitude data series is generated, for instance, by the extraction of the particular frequency components which are produced by breaking down digital audio data series along frequency domain. The means to break down digital audio data series along frequency domain is, for instance, thought to be a Digital Filter, Fourier Transformation and Wavelet Transformation and so on. Additionally, it is possible that the amplitude data series is generated with the absolute value series or RMS value series which are produced by attenuating the sound components being out of particularly voice components while emphasizing the feature of voice against acoustic noise of digital audio signals. Furthermore, there is another means using Hilbert Transformation which is mainly used to obtain the envelop.

However, in case that small amplitude zone is extracted using threshold mentioned above, the entire envelop is lifted up like shown in FIG. 4 because there is some sort of background sound in practical case. Moreover, the extent of lifted height is not constant depending upon degree of background sound. Therefore, small amplitude zone cannot be extracted from digital audio data series containing background sound by simple threshold setting. FIGS. 3 and 4 show the fluctuation of the intensity of reproduced sound, thus the intensity can be either the absolute value of the amplitude or RMS value of the amplitude itself.

Now, the bottom line 300 is generated to make the base level to produce the threshold like approximate line shown in FIG. 5 for example. The bottom line 300 is the approximate curve made in connection with the minimal values of the upper envelop line generated in the first process. And, the zone with the value being lower than the threshold made from the bottom line 300 for the certain period of time is to be a small amplitude zone.

And, in order to produce the bottom line 300 from the amplitude data series, the time constant should be set longer during the instantaneous value is increasing and shorter during it is decreasing. By using the digital value series produced by variable time constant method like the above, the bottom line 300 can be obtained from the wave having widely varied amplitude.

After small amplitude zone is extracted by the first signal processing, the second processing is executed to discriminate between a pronunciation pause zone appearing in between two vocal chunks and a simple small amplitude zone appearing due to the characteristics of a syllable. In order to make the second processing, the characteristics mentioned below is useful. That is, the time span of small amplitude zone contained in a syllable is relatively short in general. If the time span is less than 0.2 second, it can be identified to be a small amplitude zone in a syllable. On the other hand, if the time span of the small amplitude zone is 0.7 second or more, it is a small amplitude zone appearing in between two vocal chunks. The complicated factor for discrimination is what is the proper time span to specify a kind of the small amplitude zone in between two vocal chunks. But, it can identify properly the small amplitude zone in between two vocal chunks by setting the proper criteria which are determined through several experiments repeatedly done to get an empirical rule.

Furthermore, the third process specifies the location of the boundary of a small amplitude zone which is selected. When a human pronounces naturally the words, the pronunciation does not always stop, but it frequently happens that voice waves continue like glide. And, the most of the last syllable of vocal chunk have very small waveforms. Furthermore, many of syllable starting pronunciation from consonant have very small amplitude in the beginning part. FIG. 6 shows R area in FIG. 5 on enlarged time axis.

In FIG. 6, a horizontal axis 601 shows a time axis and a zero level line of amplitude signal. A curve 602 shows an amplitude curve of an envelope of signal waveforms shown in FIGS. 3 to 5. And, 603 shows zone being a vocal chunk preceding to a small amplitude zone, and 604 shows the zone being a vocal chunk subsequent to that. There is a small amplitude zone in between these two vocal chunk 603 and 604. Line 605 shows the threshold to detect a small amplitude zone. Point 606 show the time when the amplitude curve of the envelop gets lower than Threshold 605 (monotonic decline portion), and Point 607 is the time when the amplitude curve of the envelop get higher than Threshold 605 again (monotonic increase portion). Accordingly, the zone from Points 606 to 607 in between two vocal chunks is identified as a small amplitude zone. Namely, the boundary of the preceding vocal chunks 603 and the subsequent vocal chunk 604 is somewhere in this time span.

An actual boundary is supposed to be Point 608. In this assumption, if Point 609 which is a little preceding to Point 608 were judged to be a boundary, the preceding vocal chunk 603 is formed with a shortage of the zone between Point 609 and Point 608. In this condition if only vocal chunk 603 is reproduced, it make a listener feel unnatural because the listener cannot listen the last part of the vocal chunk from Point 609 to 608. On the other hand, if only subsequent vocal chunk 604 is reproduced in this same condition, the last part of the preceding vocal chunk 603 which is in between Points 609 and 608 is reproduced first and then the primary vocal chunk is reproduced. It makes the sound unnatural, too.

Since the human ear is very sensitive to language, it makes a listener unpleasant unless the boundary of the vocal chunks is judged exactly. Especially, European languages have a characteristics to contain more consonants than Japanese language, thus there is higher probability in European languages than in Japanese language to place longer consonant in between two vocal chunks. Therefore, it is important to detect precisely the boundary of two vocal chunks. As the most typical and simple example to detect a boundary, the minimum amplitude point should be detected in the zone identified to be a small amplitude zone, namely in between Points 606 and 607. The signal processing mentioned in this paragraph is the third process.

In the practical model, the third process includes not only a minimum amplitude detection method but also a method checking rate of frequency spectrum change in a small amplitude zone to enhance preciseness. In the latter method, such characteristics is used as the frequency spectrum changes largely at the boundary point where the last syllable of vocal chunk 603 is terminated to initiate the first syllable of vocal chunk 604.

And, in FIG. 6 one threshold is made but for the purpose of stabilizing the detection of a small amplitude zone, it can be accepted to make the first threshold to detect a monotonic decrease portion and the second threshold which is higher than the first one for detecting a monotonic increase portion.

Additionally, there is a boundary which has a delicate length to be judged in between vocal chunks. For instance, there is a case where the subsequent boundary of vocal chunk comes within 1.8 second from the a preceding boundary, and the latter boundary is more suitable as a boundary of vocal chunk. In such a case, two boundaries are compared, then if the latter boundary is more suitable than the former one, the former boundary should be deleted. It means the address data of the former boundary is deleted. The zone identified as a preceding vocal chunk is handled as a part of a vocal chunk one before the preceding one. On the other hand, in case the length of the zone identified as a small amplitude zone is longer than the certain criteria, it is possible that such a zone is identified as a special vocal chunk having no voice, and the starting point and ending point of such a small amplitude zone can be identified as the boundaries. In this case, since it is possible to skip vocal chunk having no voice when reproducing, no useless time can be avoidable at the time of repeat reproduction.

For the purpose of foreign language study, it is useful as well to insert a no voice zone in the boundary of the signals. That is, when people listen foreign language, it takes longer time particularly for relatively beginners to comprehend the meaning pronounced by native speakers in foreign language. In this case, it compensates the delay of the comprehension of the pronunciation in foreign language by inserting automatically a zone with no voice in between two vocal chunks at the time of reproduction and it helps a learner of foreign language to understand easily.

The voice reproduction device according to this invention has a vocal chunk extracting block and a reproduction block, and the former memorizes the location identifying information specifying the location of the boundary in extracting the boundaries of two or more vocal chunks. And, reproduction processing block reproduces the digital audio data series whose starting point depends upon the memorized location identifying information according to the reproduction control signal specifying a kind of playback mode and an operation of the device. The voice reproduction method according to this invention is materialized by the vocal chunk extracting block and a reproduction block mentioned above.

Namely, it is possible to divide the processing part to two blocks of vocal chunk extracting block which extracts vocal chunk to memorize the location identifying information of vocal chunk (the beginning address and the ending address of vocal chunk) into the memory and of reproduction processing block which reproduces the digital audio data series with a unit of vocal chunk. And, after a vocal chunk is extracted, it is possible to distribute the series of the location identifying information of vocal chunk and a digital audio data series through transmission line of either wired line like Internet or wireless line. In the data distribution system according to this invention, the data distribution station has a vocal chunk extracting block making the above-mentioned signal processing and distributes a pair of a location identifying data series of vocal chunk and a digital audio data series. In the receiving side, it is possible to make playback control according to the distributed location identifying data series of vocal chunk. In case that such a data distribution system is adopted, the vocal chunk extracting process is unnecessary at the receiving side.

As the next discussion, the noteworthy advantage of this invention shall be discussed in comparison with a conventional technique. In this patent specification, Patent Publication is listed as Patent Document 1 in Paragraph [0003] that is an example of the conventional technique. The people who try to make an educational software with an example of this Patent Publication have to edit the voice data series first in accordance with that technique, and then they have to re-store the edited voice data series with a unique recording format. Therefore, an educational material made with an ordinary music format cannot reap any benefit from this method. Though there are huge number and huge kinds of CDs with music format as an educational materials, the conventional technique has not been useful enough for those educational materials with CD or the like. This disadvantage is the same in any kind of technique invented or developed in past time.

On the other hand, in voice reproduction method according to this invention, a unique recording format is not required but an ordinary music format is possible to be used. The main reason why it is possible is because vocal chunks which no one noticed before can be extracted and voice information can be reproduced with a unit of vocal chunk. Consequently, it make us understand that this invention generates a noteworthy advantage comparing with conventional techniques.

In order to understand this invention moreover, there is one more factor being distinguished from conventional techniques. Namely, since there is a past example which distinguishes the zones with voice and with no voice, and uses the distinguished zones to control reproduction, the past examples may be misunderstood to be similar to this invention. Accordingly, the difference of those should be clearly distinguished beforehand. The first example to be possibly misunderstood is the ON/OFF control of radio wave transmission in the field of wireless communication. The second is a grouping technique using no voice zone as a voice boundary in the field of voice recognition.

But, those are all quite different from the concept of a vocal chunk. That is, the former is only to use the zone with no voice to control transmission ON/OFF of radio wave, consequently during the speaker continues speech and during transmission of radio wave is activated, many vocal chunks appear. It clearly shows it is not a technique to extract a vocal chunk.

The latter, voice recognition field, uses mainly frequency analysis and recognizes the zone with no voice in combination with the syllable analysis and syntax analysis. In the process of the analysis, the zone with no voice is used supplementarily as a boundary. The following is the explanation about the difference from a vocal chunk. When a human speaks naturally, he/she does not always follow the grammar. For instance, even in case two sentences combine each other, a human would speak in some occasion as if there were no boundary in between the end of the first sentence which is terminated with a period in written form and the beginning of the second sentence, and as if two sentences were one sentence. On the other hand, when a human speaks in thinking of the next word that he/she should speak, he/she once in a while takes a long pause in pronunciation even if it is still middle of a sentence. Vocal chunk is absolutely “a chunk” in its own term that is pronounced as a chunk, and it does not always correspond to the sentence, clause and/or phrase. The technique in the voice recognition area is the analyzing technique for searching the pronunciation pause zone in order to find the end of sentence for the purpose of its technology, namely those two techniques are different from each other by its nature.

One more difference is that the target of the technology used for voice recognition is pure voice signal only. On the other hand, the voice reproduction method and voice reproducing system of the target of this invention not only voice signal but also “the digital acoustic data series including voice data series” that means background noise is included such as in the actual society, for example background music or acoustic noise in town. As it is apparent through these difference, the technique regarding vocal chunk is different from the one used in the field of voice recognition.

In addition, the above-mentioned technique to reproduce voice signal with vocal chunks can be executed by various ways like computer program which can be distributed through wire or wireless in network, or through media like DVD, CD and/or Flash Memory.

And, the digital acoustic data series which is reproduced with the system of this invention includes compressed data. However, in case the data compressed by compression ratio of N is handled in the system of this invention, the resolution is reduced by also the same ratio, N. But, this disadvantage can be improved with the method that the pronunciation boundary of vocal chunks is defined using the data after decompression even if the source data is compressed type.

Furthermore, if the definition step of the boundary of vocal chunks in this reproduction process according to this invention is done at the time of recording process to the media (the result is stored in the memory), it is possible to reduce the processing burden at the time of reproduction process (for example, this process can be done in a server which handles the distribution of the data.)

Additionally, it is useful to add editing function to the address series (or address table) of starting and ending points of vocal chunks boundary which are extracted.

### Effects of the Invention

This invention materializes the convenient reproduction function that the conventional technique cannot do even from a voice data series that is recorded with music format. Accordingly it enhances the easiness of listening. In particular, it promotes dramatically the productivity of education in listening comprehension study.

One of the possible functions is as follows: When a listener wants to listen to the last vocal chunk reproduced, he/she just changes the vocal chunk number to the last number, then the reproduction starts correctly from the head of the last vocal chunk. The player never reproduces the data in the middle of the vocal chunk. Furthermore, the player can have a function to automatically stop reproduction at the end of each vocal chunk. In this function, after the reproduction stops once at the end of a vocal chunk, the player starts reproduction of the next vocal chunk exactly from the head of it again as soon as START icon or button is depressed.

This convenience makes it possible that a learner of listening comprehension of foreign language uses the contents which is made with ordinary music format and studies it with no frustration. Naturally, the effectiveness of the study is enhanced. Additionally, since contents on music format can be used, all contents marketed in the world with music format can be used for a listener to enjoy the above-mentioned convenience.

This convenience is not only for foreign language study. It happens frequently that people cannot catch pronunciation of their mother tongue, too. In this case people can listen the previous part in a unit of vocal chunk, thus they can catch the meaning of the pronunciation perfectly with no bothersome operation.

And, if the slow reproduction technique is installed together with this technique according to this invention, it can enhance the effectiveness of the study of foreign languages. Since slow reproduction technique is publicly well-known, it is merely an expletive function to this invention.

### BRIEF DESCRIPTION OF DRAWINGS

FIG. 1 is to show an example of a pattern diagram indicating an envelop of digital audio data series including voice signal;

FIG. 2 is to show an example of a pattern diagram indicating an envelop of digital audio data series including voice data with separate sound in its background;

FIG. 3 is to show an example of a pattern diagram of amplitude data of digital audio data series shown in FIG. 1;

FIG. 4 is to show an example of a pattern diagram of amplitude data of digital audio data series shown in FIG. 2;

FIG. 5 is to show a bottom line being an approximated curve formed by connecting minimal values of amplitude information shown in FIG. 3;

FIG. 6 is an enlarged diagram showing small amplitude zone in between two vocal chunks indicated by R in FIG. 5;

FIG. 7 is to show an example of Graphical User Interface which is used for a computer program of voice reproduction method materialized by the technique of this invention;

FIG. 8 is a block diagram to show a basic constitution (being contained in the servers which forms a part of data distribution system according to this invention and in clients terminals) in a working example using the technique according to this invention;

FIG. 9 is a flow chart to describe an interrupt process at the time of reproduction of digital audio information;

FIG. 10 is a flow chart to describe GUI control;

FIG. 11 is a flow chart to describe STOP process;

FIG. 12 is a flow chart to describe PLAY process;

FIG. 13 is a flow chart to describe SLOW Reproduction Process;

FIG. 14 is a flow chart to describe REPEAT process;

FIG. 15 is a flow chart to describe FORWARD process;

FIG. 16 is a flow chart to describe BACKWARD process;

FIG. 17 is a flow chart to describe a process to extract vocal chunks; and

FIG. 18 is a diagram to describe a configuration and voice reproduction device as an example of an information distribution system according to this invention.

### REFERENCE SIGNS LIST

100, 602 . . . envelop; 110 . . . signal waveform of digital audio data series; A1, B1, A2, B2 . . . small amplitude zone; 300 . . . bottom line; 801 . . . digital audio data series; 802 . . . voice chunk extraction part; 803 . . . Reproduction processing part; 804 . . . address series of beginning and ending point of a vocal chunk; 815 . . . vocal chunk number counter; 808 . . . reproduction starting address counter; 809 . . . reproduction stop address register; 1800 . . . network; 1801 . . . server; 1802 . . . client; 1803 - - - voice information source; and 1804 . . . information processing terminal.

### DESCRIPTION OF EMBODIMENTS

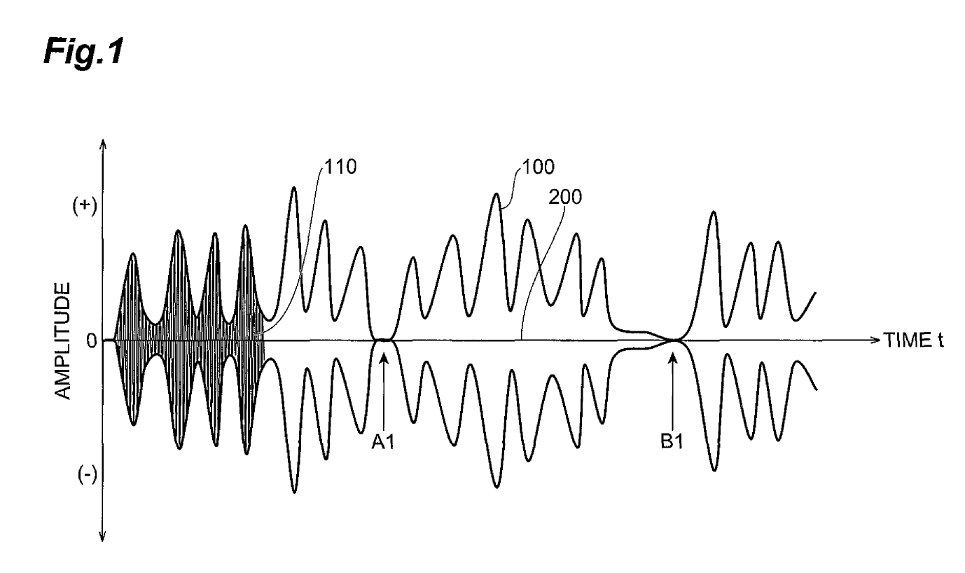

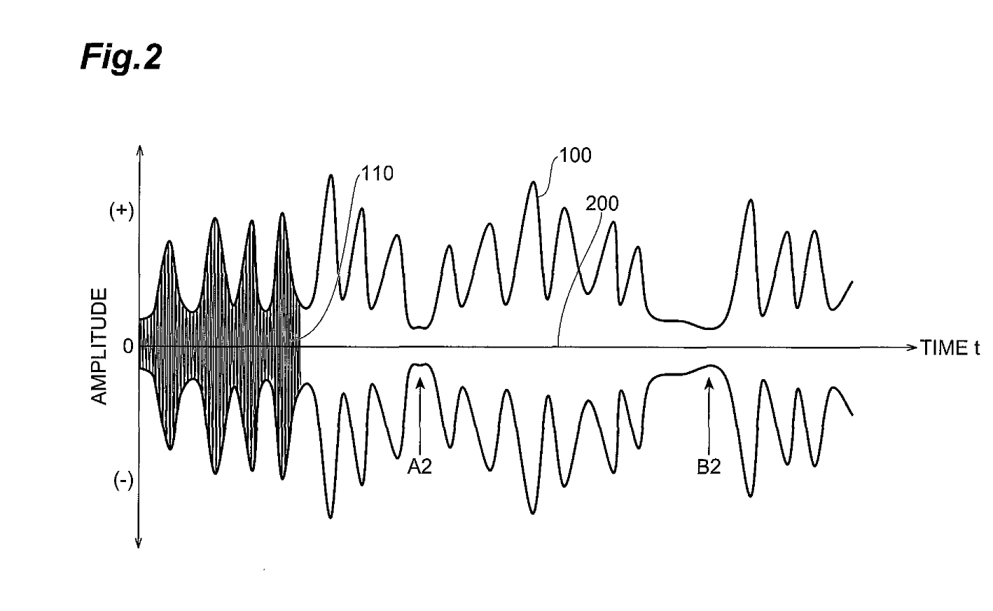

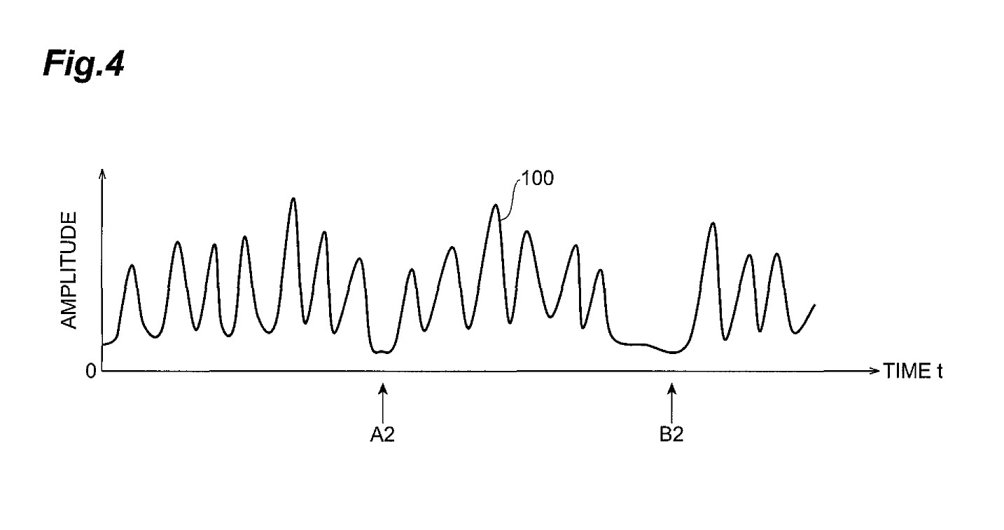

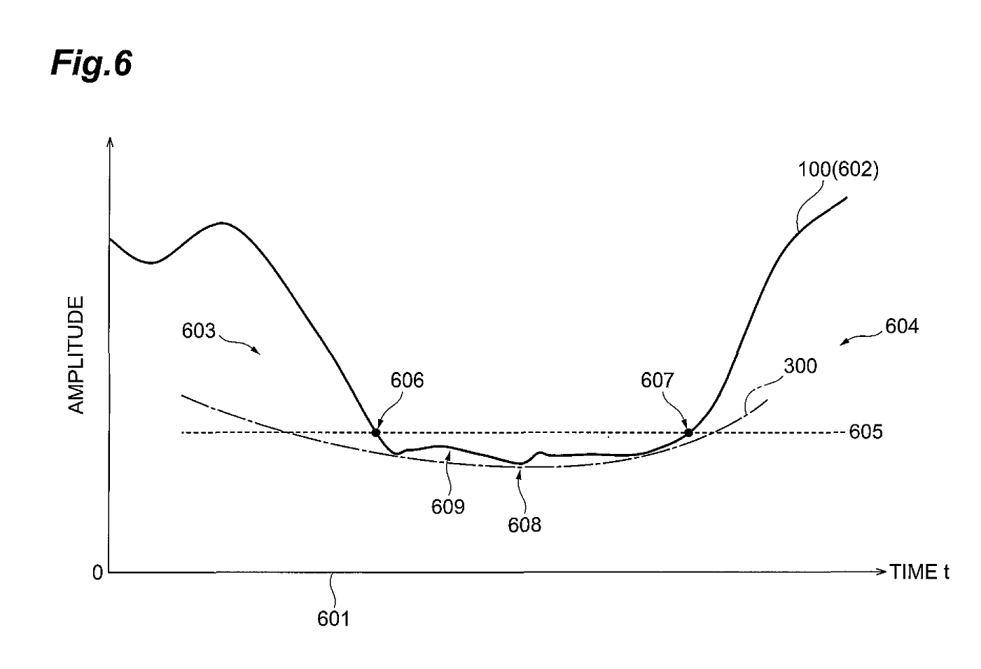

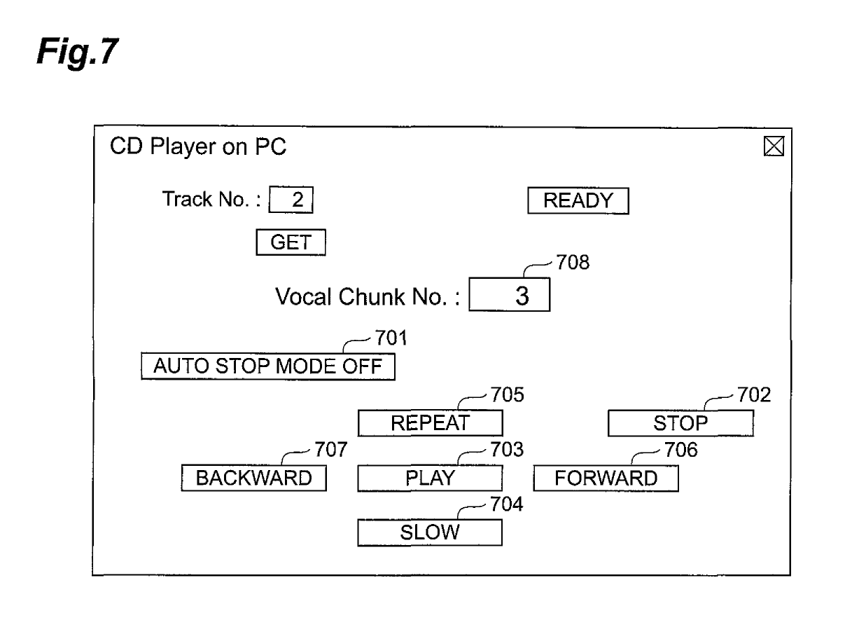

From this point, detailed description is presented with regard to voice reproduction system, voice reproduction device and voice data distribution system referring FIGS. 7 to 18. In addition, FIGS. 1 to 6 are also referred if demand arises. And, in description of Figures, same elements, a same part shall have same numbers in order to prevent double explanation.

One of the best modes for carrying out the invention in voice reproduction is a constitution comprising a reproduction program to reproduce sound on the computer and a extracting program of vocal chunk prior to the timing of reproduction. The reproduction program reproduces sound by software method in administrating boundaries allocation of vocal chunks in a system. The extracting program extracts boundaries allocation of vocal chunks.

In order to explain the reproduction program, information in a memory and several counters are explained first. At first “digital audio data series including voice data series” is placed in a memory. There is “an address counter of reproduction point” to point out particular points in the data series. Then, “addresses series of beginning and ending of vocal chunk” stores sequentially beginning and ending information of vocal chunks. Since a beginning point of each vocal chunk is the next of the ending point of the previous vocal chunk, the difference is only one in view of the reproduction address. “Reproduction Halt Address Register” has no function to count but only have a function to store an address number at which reproduction should be stopped. And, “a vocal chunk number counter” shows location of vocal chunk to be reproduced and the number of this counter is fundamental factor of reproduction control in a working model using this invention. The number of this counter is shown in GUI (Graphic User Interface) as 708 in FIG. 7. It means a current number of vocal chunk to be reproduced.

Next subject is a matter of flags which have important roll for the reproduction program. At first, “Reproduction Flag” is to control reproduction, namely “1” means reproduction and “0” means not-reproduction. “Auto Reproduction Halt Mode Flag” is a flag to set an auto reproduction halt mode. “Repeat Reproduction Flag” is a flag to set a repeat mode.

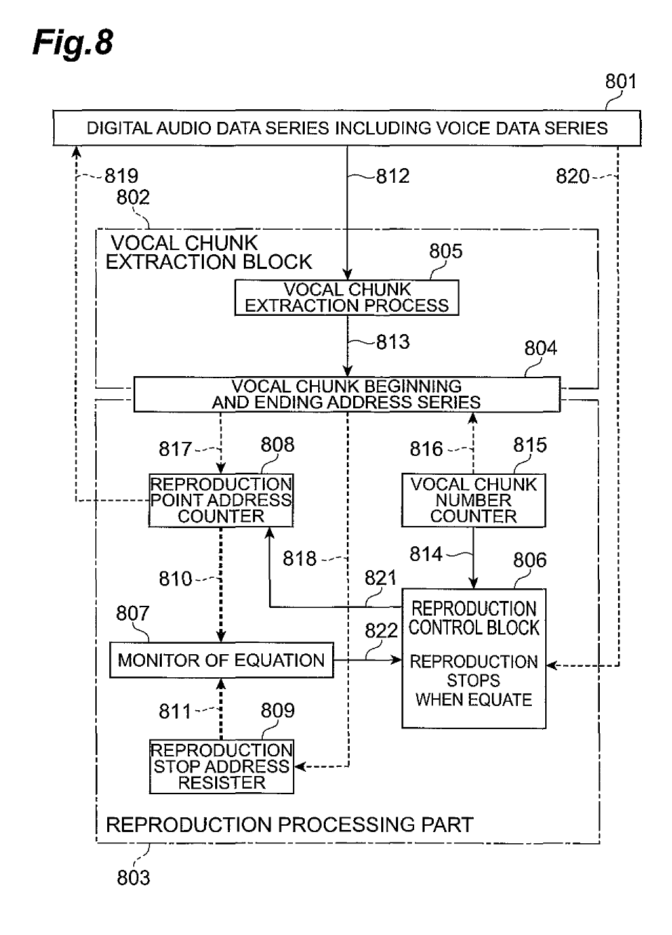

The basic structure of reproduction process is described using FIG. 8 and it is a block diagram to show the basic structure of processing in a voice reproduction method and a voice reproduction device according to this invention, and processing blocks and the flow of the processing in a memory are drawn together. Additionally, data distribution system depending on this invention is configured with information processing terminals like a computer connected to Internet line or the like and the basic structure shown in FIG. 8 is same as the basic structure of the combination of a server and a client terminal which make a part of the distribution system. At first, 801 is a digital seamless audio data series comprising voice data series to be reproduced.

A vocal chunk extraction part 802 comprises a vocal chunk extraction process 805. And, a reproduction processing part 803 comprises a reproduction control part 806 which controls audio reproduction. And, a reproduction processing part comprises a processing part 807 which monitors whether a value 810 of a reproduction address counter 808 accords the value 811 of a reproduction stop address register 809.

At first, a vocal chunk extraction process 805 being done in a vocal chunk extraction part 802 is to take a digital signal 812 comprising a digital audio data series 801 including at least a voice data series, then to extract all vocal chunks in order to add the starting addresses and ending addresses 813 of each vocal chunk to a vocal chunk addresses series 804.

Once a vocal chunk is extracted, it is possible to reproduce the said vocal chunk. Thus, it is not necessary to wait for the completion of the extraction. When at least two vocal chunks are extracted to store their addresses to a vocal chunk addresses series 804, it is possible to start reproduction. Using multi task process, from the view of a user, during a reproduction part 803 works, a vocal chunk extraction part 802 is doing in parallel a vocal chunk extraction process 805. However, to make multi task process possible, processing speed of a vocal chunk extraction part 802 must be greater than that of a reproduction process part 803. It was proven to be workable in an ordinary personal computer sold in the market at this time.

Furthermore, vocal chunks extracted by detecting boundaries of vocal chunks may have a delicate length (for example, the first vocal chunk is over then the second vocal chunk starts, but it may happen the boundary comes in a short period of time like 1.8 second right after a new vocal chunk starts. And, the new boundary is more suitable for a boundary of a vocal chunk than the prior boundary.) In case if the second boundary is more suitable than the first one when the second boundary is compared with the first one, then the address information of the first boundary should be deleted (An address table of vocal chunks is renewed, too.) In this case, a zone judged as a previous vocal chunk should be identified to be a part of a latter vocal chunk. On the other hand, in case the small amplitude zone selected has longer time than a certain criterion, such zone as having no voice is identified to be a special vocal chunk, then the beginning address and the ending address of such zone are recognized as the boundaries of a special vocal chunk. In such a case, skip operation is possible at no voice zone in reproduction mode, thus useless time consumption is prevented when repeat playback is done.

For the purpose of foreign language study, it is useful to insert the certain time interval into boundaries. Namely, when people listen to foreign language, it takes longer time for them to catch its pronunciation and comprehend what it means than they do in their mother tongue. In such a case, inserting automatically no sound zone into boundaries of vocal chunks can compensate the delay of comprehension, and consequently it improves productivity of study of a foreign language.

Next is the description of process in reproduction process block 803 in FIG. 8 in case of reproduction of a single vocal chunk. First, in a control 814 at a reproduction control block 806, such a starting information 817 that is extracted from a vocal chunk beginning and end address series 804 and that is corresponding to a vocal chunk number 816 stored in a current vocal chunk counter 815 is set in a reproduction point address counter 808. And, an ending address 818 taken from a vocal chunk beginning and ending addresses series 804 is loaded to a reproduction stop address register 809. Then, such an audio information 820 is taken as corresponds to an address 819 set in a reproduction point address counter 808 transferred from a vocal chunk beginning and ending address series 804, and an audio information 820 is loaded to reproduction control block 806.

The roll of a reproduction block 806 is to output an audio information 820. When an audio information 820 is output, a reproduction point address counter 808 receives a command 821 from a reproduction control block 806 to be counted up plus 1. Then, the reproduction point advances one forward. And, a monitoring process block 807 compares a starting point address 810 with an end point address 811, then if they are coincidence, a detecting signal 822 is sent to a reproduction control block 806.

The following is an explanation of a processing flow from different view point. Process for reproduction comprises two major parts. One is an interrupt routine synchronizing with sampling rate for sound wherein sound is reproduced by each interrupt. The other is a main routine which works according to a click signal from GUI in FIG. 7 activated by an operator. In a GUI, there is an ON-OFF icon 701 for auto stop mode which works as an alternate action. Namely, when the icon 701 is clicked during OFF mode, the mode changes to ON and vice versa. An auto stop mode flag gets 1 when the mode is ON and 0 when the mode is OFF.

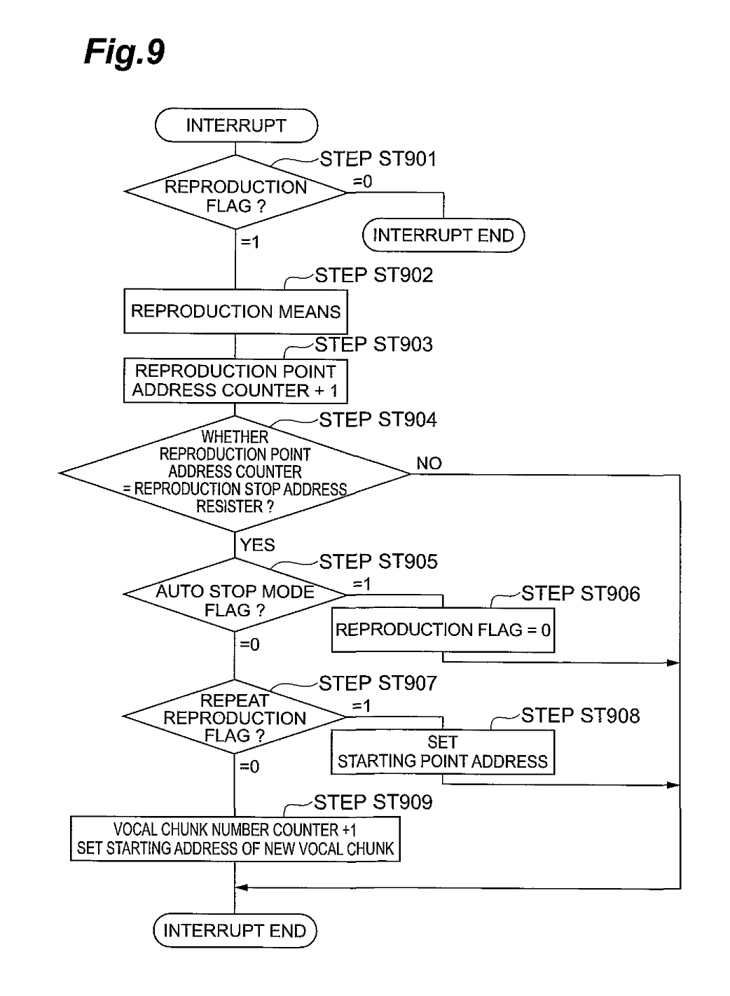

Then, an interrupt routine shall be explained using FIG. 9. First, a reproduction flag is checked (Step ST901). If a reproduction flag is 0, an interrupt routine stops without reproduction. If reproduction flag is 1, Step ST902 is executed. In Step ST902, an audio information is picked up from an audio data series 801 which includes a voice data series located in a memory according to the address in reproduction point address counter 808, then the audio information is transferred to a reproduction control block 806 (reproduction means). In a reproduction control block 806, an audio data series transferred is reproduced to output as a sound, but the reproduction means is generally well-known, thus the explanation of the means shall be omitted.

Then, the process proceeds to Step ST903 wherein a reproduction point address counter 808 is counted up plus one. Subsequently in Step ST904 it is checked by a processing block 807 whether a value of a reproduction point address counter 808 is equal to a value of a reproduction stop address register 809. If not equal, the interrupt routine is over to make a process move back to a main routine.

If the result in Step ST904 is equal, an auto reproduction stop mode flag is checked (Step ST905). In case that an auto reproduction stop mode flag is identified to be 1, a reproduction flag is set to be 0 (Step ST906). Then, when the next interrupt comes in, reproduction stops since a reproduction flag is checked in Step ST901 and it is 0 at that time. When a reproduction flag is set to be 0 in Step ST906, an interrupt routine is completed.

In case that an auto reproduction stop mode flag is confirmed to be 0 at checking operation in Step ST905, a replay flag is checked (Step ST907). If a replay flag is 1, starting point address is set to a reproduction point address counter 808 (Step ST908), the interrupt routine is over. Through this operation, reproduction starts from the beginning of the same vocal chunk. Namely, repeat reproduction starts. On the other hand, when replay flag is identified to be 0 in Step ST907, a vocal chunk number counter 815 is counted up plus 1, then the starting point address of a new vocal chunk is set to a starting point address counter 808 (Step ST909) in reference to a vocal chunks beginning and ending addresses series 804. And, when a process of Step ST909 is completed, the interrupt routine is over, too. Through this operation, the beginning of the next vocal chunk is reproduced when the next interrupt comes in. In this case, the next vocal chunk is reproduced continuously as the vocal chunk number increases, thus a listener can listen sound contents just same as an ordinary CD player.

Here, vocal chunk number is explained. It might not be the best way to compare, but the conventional tape recorder is taken for comparison for making it easy to understand. Vocal chunk number resembles the tape counter number to indicate the location of the reproduction. If taking CD player for comparison, decay time counter resembles the number of a vocal chunk. However, the counter of such conventional sound reproduction devices indicates only physical position on a tape or a disk but does not indicate the position of a unit which a listener wants to listen. On the other hand, the vocal chunk number of this invention shows a unit of a chunk which a listener wants to listen at one time, therefore, the operation, even going forward or backward, is done comfortably. No other sound device gives us this comfortableness.

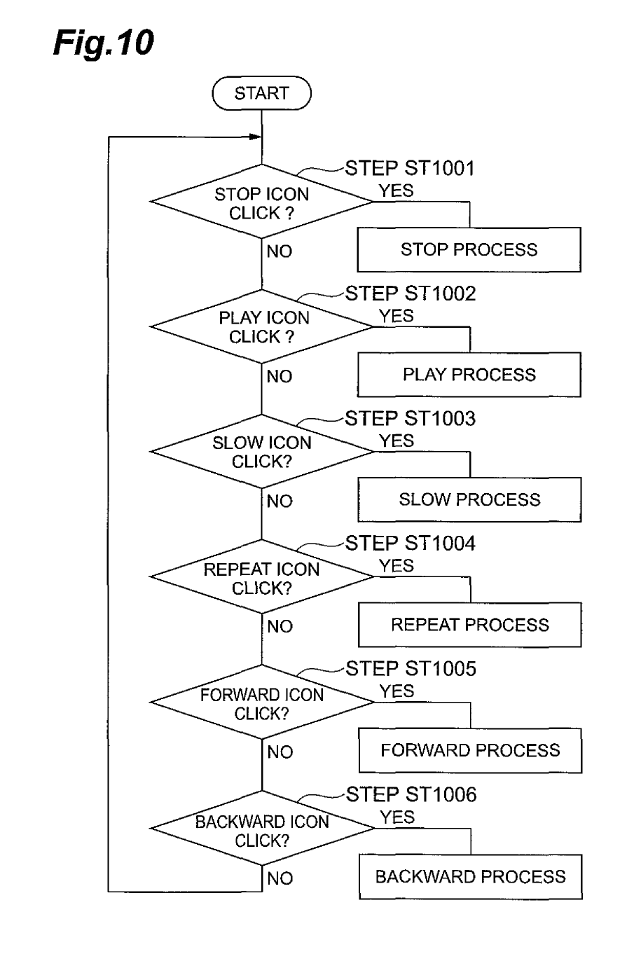

From this paragraph the basic flow of the program working according to the instruction of an operator through GUI shown on a screen in FIG. 7 is explained using FIGS. 10 to 16.

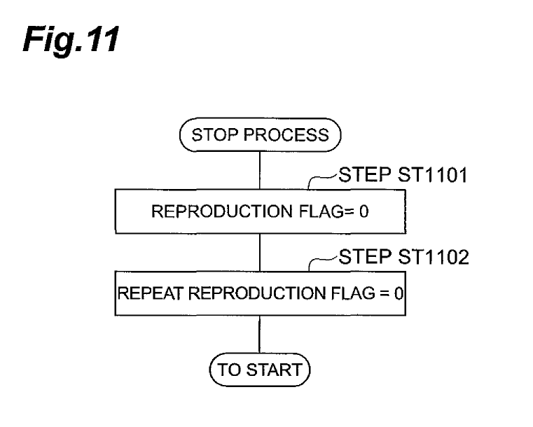

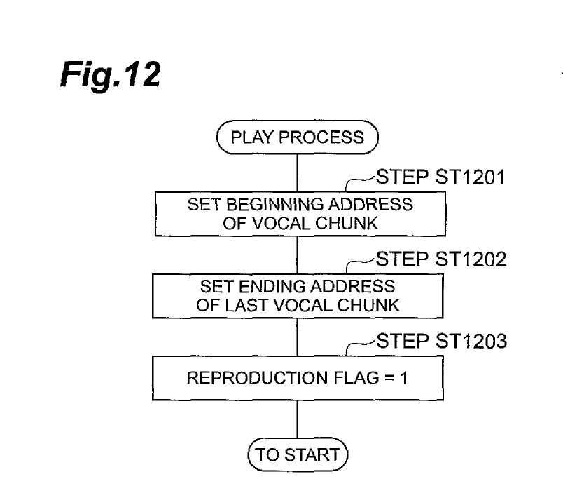

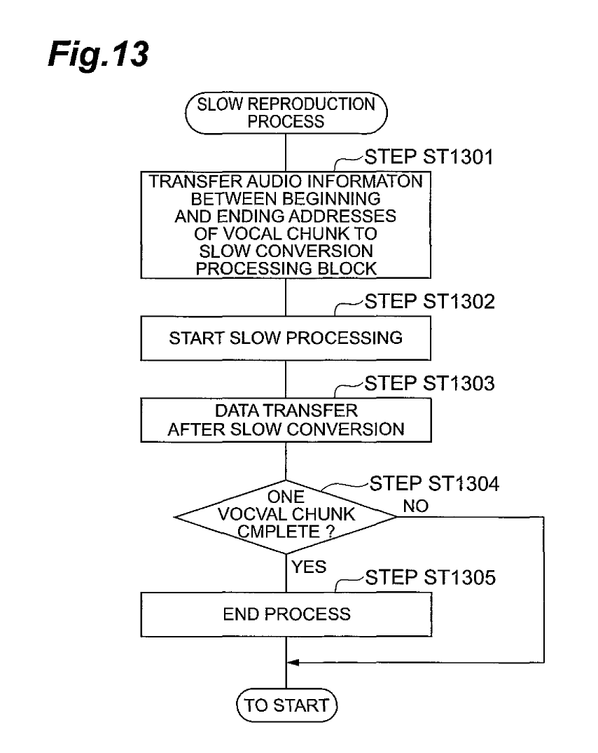

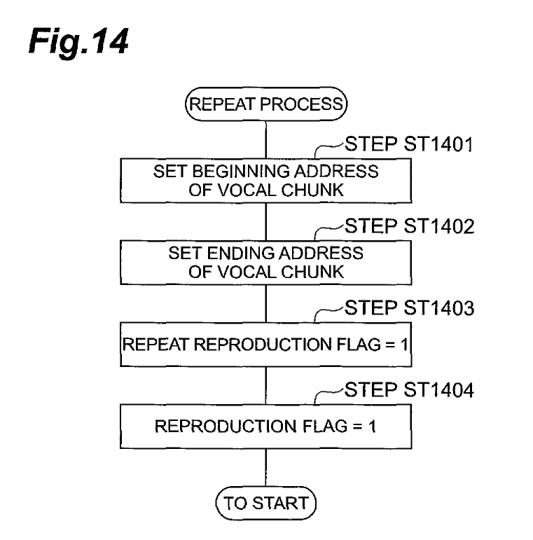

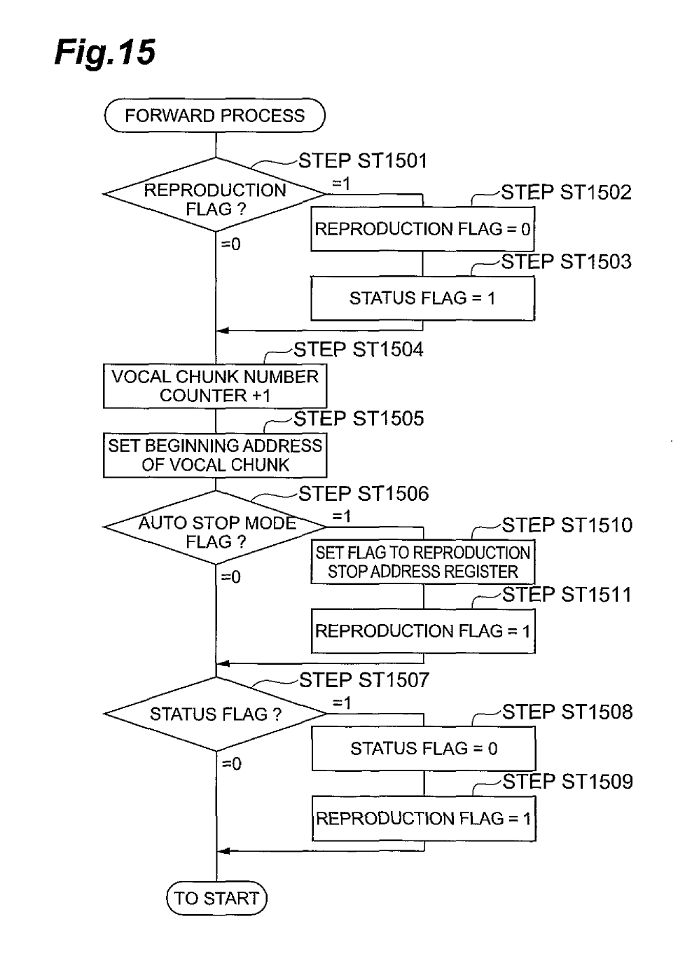

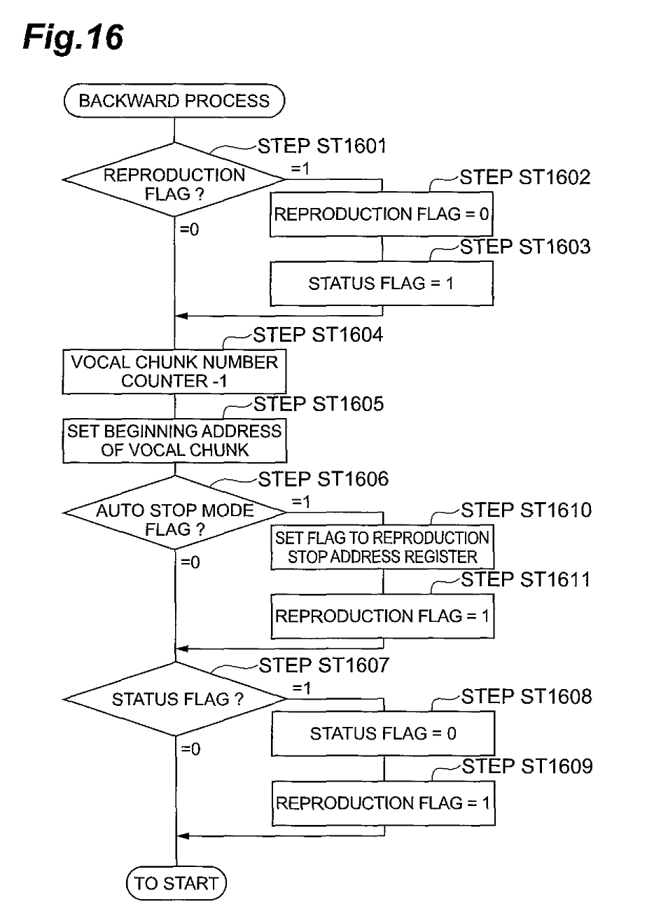

In FIG. 10, when STOP icon 702 in FIG. 7 is clicked (step ST1001), STOP process is executed (FIG. 11). When PLAY icon 703 is clicked (step ST1002), PLAY process is executed (FIG. 12). When SLOW icon 704 in FIG. 7 is clicked (step ST1003), SLOW replay process is executed (FIG. 13). When REPEAT icon 705 in FIG. 7 is clicked (step ST1004), REPEAT reproduction process is executed (FIG. 14). When FORWARD icon 706 in FIG. 7 is clicked (step ST1005), FORWARD process is executed (FIG. 15). Furthermore, when BACKWARD icon 707 in FIG. 7 is clicked (step ST1006), BACKWARD process is executed (FIG. 16).

In STOP process (FIG. 11) mentioned above, first, reproduction flag is set to be 0 (step ST1101). Then, repeat reproduction flag is set to be 0, too (step ST1102). In this operation, reproduction is stopped even if either ordinary reproduction or repeat reproduction works.

In PLAY process (FIG. 12), the starting point address 817 of the vocal chunk beginning and ending address series 804 taken from the vocal chunk number (vocal chunk number 708 in FIG. 7) stored in vocal chunk number counter 815 is set into the reproduction point address counter 808 (step ST1201). Subsequently, an end point address 818 of the last vocal chunk located in a vocal chunk beginning and ending address series 804 is set into a reproduction stop address register 809 (step ST1202). Then, in a step ST1203, reproduction flag is set to be 1, after that, the control program returns to START in FIG. 10. Through this action, if no icon is clicked after PLAY is clicked, the sound contents is reproduced up to the final chunk continuously.

For the next step, in SLOW reproduction process (FIG. 13), the audio data series including voice data series according to the starting point address and ending point address of the vocal chunk specified by a vocal chunk number counter 815 is extracted from a digital audio data series 801 and then is transferred to a reproduction control block 806 (including SLOW processing block) (step ST1301). Consequently, the conversion process to reproduce voice with slow speech speed is executed (step ST1302). In addition, it is not shown in GUT in FIG. 7 but it is preferable to design the reproduction system which enables an operator to select the conversion ratios of SLOW reproduction (for example, the ratio to standard reproduction speed). And, in step ST1303, a vocal chunk is reproduced with the speed converted there. When reproduction is over, it is check whether or not all of the specified vocal chunks are completed to be reproduced (step ST1304). If not completed, it returns to starting point shown FIG. 10. In step ST304, if the vocal chunk is completed to be reproduced, completion process of SLOW reproduction is executed (step ST1305), then returns to starting point shown in FIG. 10. This process is done using interrupt routine in step ST1303 to reproduce sounds like the process shown in FIG. 9. However, since this does not have a purpose to explain SLOW reproduction in detail, it is enough to indicate that SLOW reproduction is possible.

In REPEAT process (FIG. 14), a vocal chunk starting point address 817 extracted from a vocal chunk beginning and ending addresses series 804 is set to reproduction point address counter 808 (step ST1401). Then, a vocal chunk end point address 818 is set to a reproduction stop address register 809 (step ST1402). When address setting is over, repeat reproduction flag is set to be 1 (step ST1403), furthermore, reproduction flag is set to be 1 (step ST1404), after that, it returns to starting point in FIG. 10. Through this process, when REPEAT icon is clicked in FIG. 7, the single vocal chunk is reproduced from its starting point to its end point repeatedly.

In FORWARD process (FIG. 15), at first reproduction flag is checked (step ST1501). In case of reproducing sound, reproduction flag is set to be 0 (step ST1502) to stop reproduction temporarily. And, after status flag is set to be 1 (step ST1503), it proceeds to step ST1504. In step ST1504, number of one is added to the number of vocal chunk number counter 815. And then, a starting point address 817 read from a vocal chunk beginning and ending address series 804 according to a number stored in vocal chunk number counter 815 is set to reproduction point address counter 808 (step ST1505).

In step ST1506, an auto reproduction stop mode flag is checked. In case an auto reproduction stop mode flag is 1, vocal chunk number counter 815 is referred (corresponding to 708 in FIG. 7) in step ST1510, an end point address 818 read from vocal chunk beginning and ending addresses series 804 is set to a reproduction stop address register 809.

At this time, in a step ST1504 prior to a step ST1506, vocal chunk number is counted up to indicate a new vocal chunk. And, in a step ST1511, reproduction flag is set to be 1, then the process goes to a next step ST1507. Through these process, when FORWARD icon 706 is clicked under an auto stop mode, vocal chunk advances one, then the vocal chunk is reproduced. Further, the reason why the process goes to a step ST1507 after a step ST1511 is because the process for a status flag should be done at the same time, if the timing when FORWARD icon 706 is clicked would be during reproduction, namely it is because the process from a step ST1507 to step ST1509 must be done.

On the other hand, in step ST1506, if an auto reproduction stop mode flag is 0, a status flag is checked (step ST1507). If a status flag is 1, a status flag is set to be 0 (step ST1508) and at the same time a reproduction flag is set to be 1 (step ST1509), then the process returns to START in FIG. 10. If a status flag is 0 in a step ST1507, the process returns to START in FIG. 10 with no action.

The process when BACKWARD icon 707 is clicked is shown in a flow chart drawn in FIG. 16. The process for BACKWARD is identical to the process for FORWARD shown in FIG. 15 except the process in a step ST1604. Namely, steps ST1601 to ST1603 and ST1605 to ST1611 in FIG. 16 are substantially identical to steps ST1501 to ST1503 and ST1505 to ST1511 in FIG. 15. A vocal chunk number counter 815 is counted up one in a step ST1504 of FORWARD process in FIG. 15, on the other hand in BACKWARD process in FIG. 16, a vocal chunk number counter 815 is counted minus one in a step ST1604. That is, the difference is that a vocal chunk number steps ahead or steps back. Therefore, explanation about the process in the other steps is omitted.

As understandable through FIGS. 10 to 16, the reproduction of each vocal chunk always starts from its head no matter which icon like PLAY, SLOW, REPEAT, FORWARD and BACKWARD in FIG. 7 is clicked. Namely, it never reproduces voice from a middle part of a vocal series that makes a listener uncomfortable, thus a listener can confirm the contents by repeating comfortably. As explained here, a voice reproduction method according to this invention is realized particularly for making a listener comprehend the contents not like a music, furthermore audio data series made of music format can be used for reproduction.

Additionally, above-mentioned explanation about functions is just a phase of working examples by this invention, thus further several functions are added to practical machines based on this invention. For example, it becomes possible to repeat reproduction of plural vocal chunks that are specified by the beginning vocal chunk number and the ending one. Moreover, several examples of application using vocal chunk are conceivable, those examples are duly included as an application of this invention.

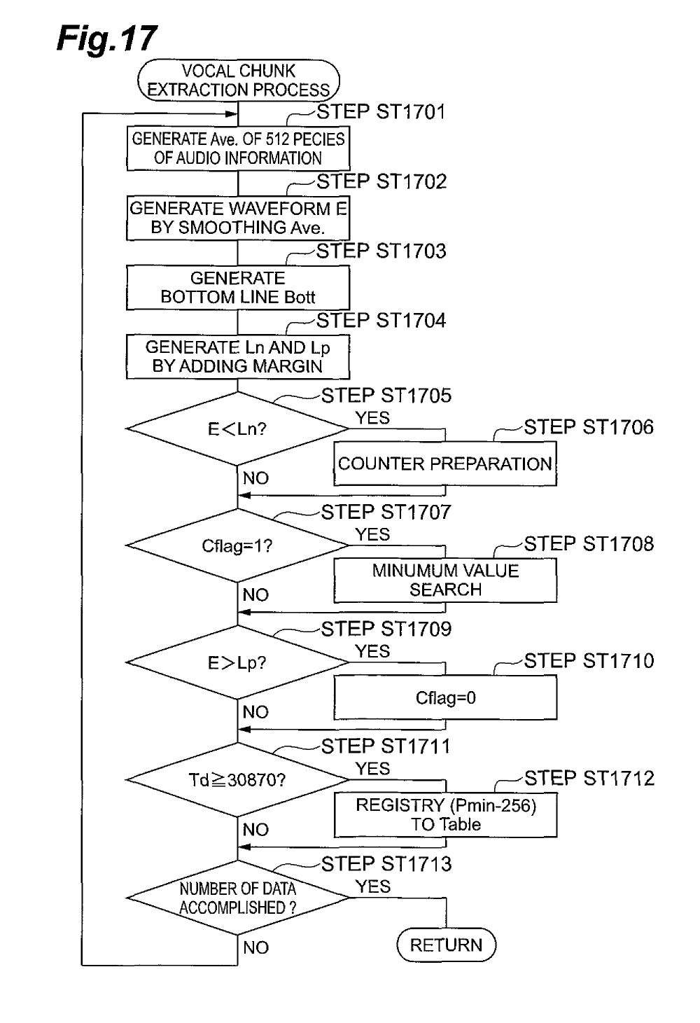

Then, as a next step, vocal chunk extraction process 805 is disclosed using a flow chart in FIG. 17 wherein vocal chunks are extracted from an audio data series including a consecutive voice data series. Before that, a digital audio data series including a voice data series should have be explained clearly. The most popular recording media to record a digital audio data series including at least a voice data series is CD-DA. The sampling rate is 44100 sample/second. The sampling interval is 22.68 micro second. And, an audio data series to be processed in this manner is supposed to be placed in a memory (corresponding to a digital audio data series 801). Since the technique to place the data in a memory is publicly known, the explanation is omitted. In order to count a datum in a digital audio data series, a variable named Posi is assigned. At the head of an audio data series Posi=0 is set. For example, Posi becomes 441,000 after 10 second later.

When a vocal chunk extraction sub program shown in FIG. 17 is initiated, 512 pieces of audio amplitude information is averaged (step ST1701). If separately counted the right channel and left channel of stereo data, 1024 pieces of audio amplitude information is counted for averaging as a chunk. If counted from the head of the information for Posi, it corresponds to the number of 0 to 511. Since fine resolution like 22.68 micro second is not necessary for the analysis, the audio data can be chunked. The number 512 does not have particular meaning but just a number for design matter.

An average value of a bunch of audio amplitude information is a variable, Ave. The first Ave is made then the process advances to a step ST1702. When the process goes to a step ST1702, Posi is supposed to be 511. At the second time, it should be Posi=1023. The value of Posi is used in a step ST1706. Namely, the process of a step ST1702 or subsequent processes is supposed to be executed with 512 pieces of original audio information.

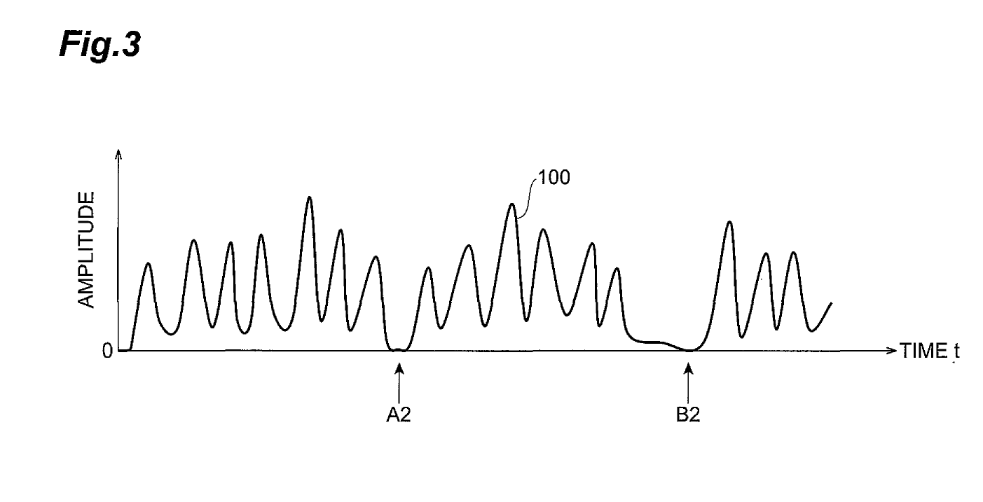

In a step ST1702, Ave is processed through LPF whose cutoff frequency is approximately 2 Hz to generate a variable, E. If the wave form of a variable, E is monitored to be seen, it looks like an envelop waveform shown in FIGS. 3, 4 and 5.

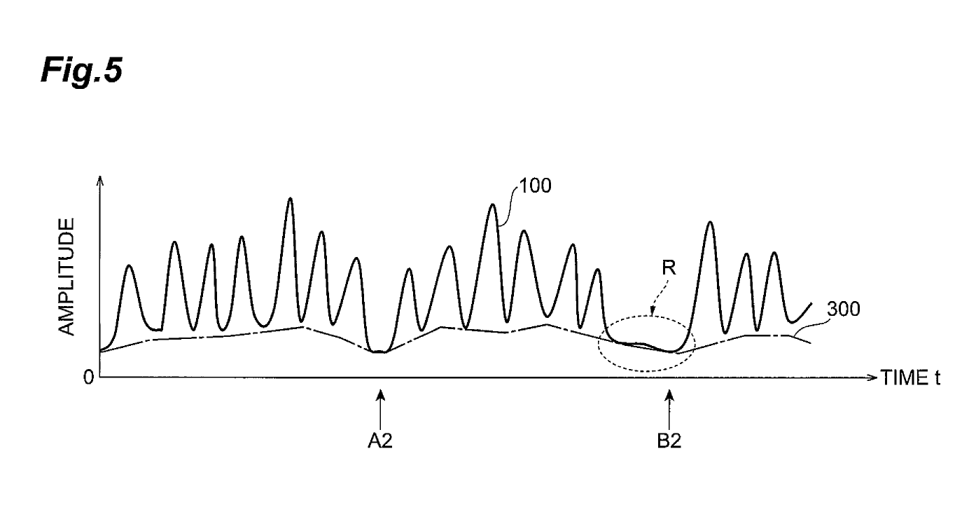

In a step ST1703, a curve connected each bottom point (local minimal value) of an up and down wave made of variable, E forms approximated bottom line. The instantaneous value of the approximated bottom line is named a variable, Bott. A variable Bott is shown in FIG. 5 as 300.

In a step ST1704, a pair of threshold Ln and Lp is generated by adding margins to Bott. Ln is a threshold (the 1^{st} threshold) that is crossed by a variable, E when it comes down from higher to lower points (at flatly decreasing region), and Lp is a threshold (the 2^{nd} threshold) that is crossed by a variable, E when it goes up from lower to upper points (at flatly increasing region). And, saying relation between the 1^{st} threshold and 2^{nd} threshold, relation of Ln<Lp is proved. This relation makes a hysteresis between upward and downward motion when a variable, E changes in a small range in order to make function stable. The detailed explanation is omitted because such a roll of hysteresis is well-known as making the function stable.

The first step of process starts from a step ST1705. In here, it is judged whether the relation E<Ln is proved. When E<Ln, the process goes to a step ST1706, then it is prepared to count time period during E is less than Ln. Namely, a flag Cflag is reset and a variable Td is cleared to be zero. A variable Td is one to count time during a variable E is below a threshold. At the time when a variable E gets less than a threshold, the variable should be cleared. The variable Td is used in the second process. In a step ST1706, the preparation is made to catch a minimum value of Ave which is used in the third process. It means initialization of Amin which indicates minimum value like Amin=Ave.

In a step ST1707, it is judged whether Cflag=1 is true. If Cflag=1, the process goes to a step ST1708 and 512 is added to a variable Td. The reason why 512 is added is that a variable E is formed with 512 pieces of original audio informations in an audio data series to make a bunch. In a step ST1708, one more process is executed. That is, such process is initiated as for searching the point being a minimum value of a variable Ave. The way to search a minimum value is that a variable Amin is renewed to be new Ave only in case of Ave<Amin. Through these process, Amin indicates a minimum value during the time until this point. The process to make Pmin=Posi only when Amin is renewed. That is, the position at that time in an audio data series is stored into Pmin. In other words, this process is used to define each boundary position of two vocal chunks through the second and the third process after the first process is completed as mentioned later.

In a step ST1709, it is judged whether E>Lp is true or not. If the inequality sign is true, the process goes to a step ST1710 and then a flag Cflag is set to be 0. That is, a counting operation is stopped. Through this, the first process is completed.

Subsequently, the operation of the second process starts. That is, in a step ST1711, a variable Td which was counted up is judged. The most simple judgment is to check whether or not Td is equal or greater than 30870 which means 0.7 second or more. If inequality sign is true, the process goes to a step ST1512.

And, a step ST1712 is the center of the third process. That is, the above-mentioned the value of Pmin minus 256 is a boundary address of a vocal chunk, then it is stored in vocal chunk beginning and ending address series as the beginning address of a vocal chunk. Then, the one point prior the point is registered into the beginning and ending address series of vocal chunks as an end point of a last vocal chunk. Additionally, the reason why 256 is reduced from Pmin is that Ave being judged is formed with 512 pieces of audio data series. Therefore, 256 must be reduced to determine the center of a vocal chunk. The process until this point is the third process.

Concerning the second process, more precise judgment is done if using a personal computer sold in the market. The basic method is same as mentioned above. And, in the third process as well, it is not limited to use the judgment of minimum value.

Then, the processes from a step ST1701 to a step ST1712 are repeated on the data from beginning to end on an audio data series including a voice data series. Through a series of these processes, location identification information on a vocal chunk, namely a vocal chunk beginning and ending address series 804 are completed.

The media which stores a computer program to execute the process mentioned above is also a part of the invention.

And, it is possible to divide the system to two blocks, one block is to store the location identifying information (concretely, a vocal chunk beginning and ending address series) after extracting vocal chunk from voice data series, the other block is reproduction process to reproduce vocal chunks according to address information. With using this method, it is possible to distribute digital audio data series including voice data series together with vocal chunk location identifying information through communication lines like Internet or the like. In a receiving side, reproduction can be controlled using vocal chunk location identifying information. In this case it is not necessary to extract vocal chunks and create vocal chunk location identifying information in receiving side.

### Specific Example 1

There are two major means to materialize a voice reproduction device or an audio player using the voice reproduction method according to this invention. One is a software player working on a computer, either desk top type or portable type. The other is a portable digital music player. The former is materialized by computer program already mentioned above, so here the working sample is explained about the latter case.

Operation buttons of a digital music player stay as they are. As the operation mode, the reproduction mode according to this invention is added to the operation mode for music. Furthermore, the reproduction mode has at least two types of mode. That is auto stop ON mode and its OFF mode.

When auto stop mode OFF is selected, most of the functions are same except two differences. The first difference is the reproduction location counter shows vocal chunk number instead of time decay or tape length. The second difference is jumping the position with a unit of vocal chunk number when Forward button or Backward button is depressed. And, even if reproduction stops in the middle of a vocal chunk by depressing STOP button, reproduction starts again from the head of the vocal chunk when START button is depressed. Additional mode (that is Auto Pause Mode) will be useful for language study under which pause time is inserted automatically with no signal in between two vocal chunks.

Then, auto stop ON mode is explained next. The motion of this mode can not be materialized in an ordinary music player. When it is completed to reproduce a vocal chunk, reproduction stops automatically at the end of the vocal chunk. And, a vocal chunk number stays same without depressing FORWARD or BACKWARD button. Under this mode, only one same vocal chunk is reproduced every time when PLAY button is depressed. If FORWARD button is depressed, the next vocal chunk is reproduced once. If BACKWARD button is depressed, the previous vocal chunk is reproduced once.

If this reproduction system is installed in the portable digital music player, it became possible to reproduce huge number of listening study contents using this system.

And then, there is an example to provide market with the reproduction system as a program of computer.

It is possible to adopt this technique to distribution system in a network. After vocal chunk location identifying information is generated in a computer in distribution server, a digital audio data series including a voice data series is distributed through a network like Internet with vocal chunk location identifying information, concretely a starting point and ending point. In the receiving side, audio information is reproduced and reproduction is controlled with vocal chunk using vocal chunk location identifying information. In this method, it is not necessary to extract vocal chunk in reproduction side.

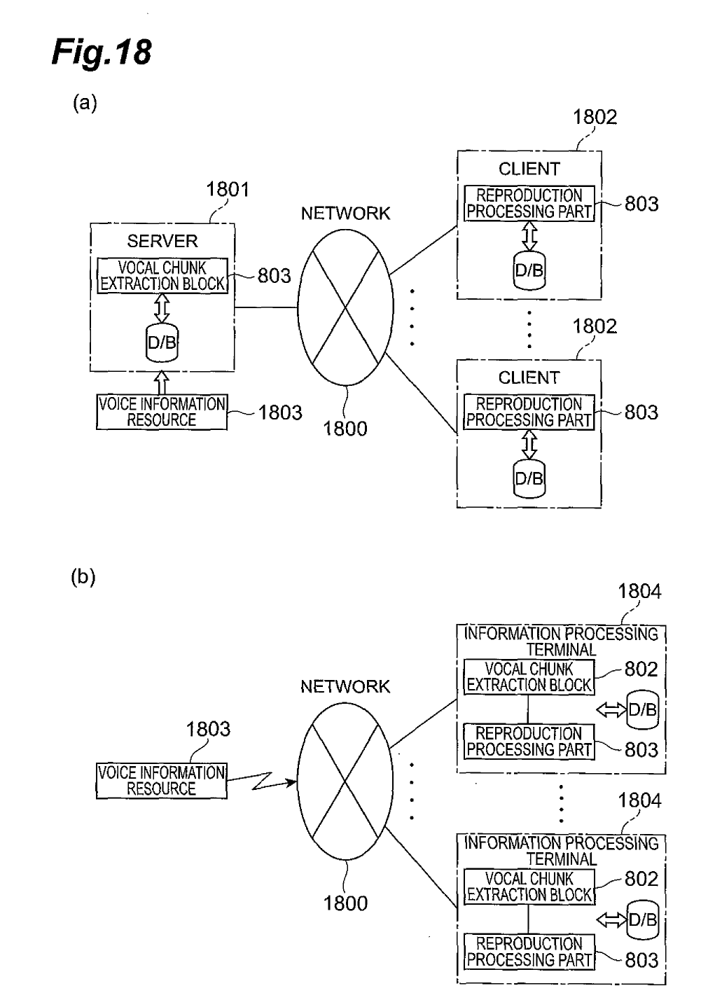

As the next step, area (a) in FIG. 18 shows the constitution of distribution system according to this invention, area (b) is a figure to explain a working configuration of a voice reproduction device based on this invention.

As shown in area (a), the distribution system based on this invention configures a server 1801 connected with each other through a network 1800 and plural clients 1802. A server 1801 contains a database (D/B) which temporarily stores digital audio information received from voice information source 1803 and the data for distribution and a voice extraction block 802 shown FIG. 8. A voice extraction block 802 converts a digital audio data series to an amplitude data series which can be judged to detect boundary addresses of two or more vocal chunk contained in the said series using threshold. The threshold is generated from the amplitude data series. And, using the threshold generated, a small amplitude zone is extracted from the amplitude data series converted. Furthermore, in a voice extraction block 802, real small amplitude zones in between each two vocal chunks are selected from small amplitude zones extracted from the series. And, the boundary addresses of two vocal chunks are extracted sequentially as location identifying information. The server 1801 distributes a digital audio data series as well as location identifying information of vocal chunks extracted in extracting block 802 to each client 1802 through a network 1800.

In case an amplitude data series converted from a digital audio data series is one kind, it is enough to use a kind of amplitude data series to generate a threshold and to judge a boundary address. However, in order to detect more precisely boundary addresses, at least two kinds of amplitude data series should be generated from a digital audio data series. And, one (the first amplitude data series) is used for generation of threshold and the other (the second amplitude data series) can be used as well for detection of boundary address (but, the case that one kind of an amplitude data series is generated means two types of amplitude data series are identical.)

On the other hand, each of plural clients terminals 1802 which is connected to a server 1801 through a network 1800 complies database (D/B) stored temporarily the data distributed from a server 1801 through a network 1800 and reproduction processing block 803 shown FIG. 8. In the reproduction processing block 803, vocal chunks are reproduced according to starting and ending points of the location identifying information.

And, voice reproduction device shown in FIG. 8 can be installed in an information processing terminal 1804 as a software through a network 1800 shown in area (b) in FIG. 18. In this case, each information terminal 1804 comprises a voice extraction block 802, a reproduction processing block 803 and a database (D/B) storing temporarily data to be processed. In this configuration, each information processing terminal 1804 can reproduce the voice data down loaded through a network 1800 from a voice information source 1803 using this voice reproduction system.

Through the description of this invention, it is apparent to make several types of working style. Those variations are not identified to be out of the extent of the idea of the invention and the improvement which is apparent to all people skilled in the art is in what is claimed below.

### INDUSTRIAL APPLICABILITY

Listeners who want to listen an audio data series including voice data series can use huge number of contents available in market which are made with music format without changing format under this system. Furthermore, they can enjoy ultra convenience which is not materialized with the conventional technique, as the result the productivity of study can be surely improved. And, educational contents editors can make the contents with same conventional music format as they have used. Therefore, this invention contributes the industry area where they make the contents rather than music.

Internet radio stations which distribute a voice data series like news are getting popular, and when foreigners listen the voice which is not their mother tongue, it is possible to listen carefully vocal chunk one by one if they use the player embedded the system based on this invention. Particularly when the listeners listen news they can enjoy listening more because professional announcers can pronounce clearly a unit which includes meaning, that is a vocal chunk. It has been proven by an experiment.

Additionally, this invention is not limited in foreign language education field to realize the convenience. For example, eye disable people get the information through voice more than ordinary people do. For those people the player with this reproduction mode is useful and convenient.

Reproduction mode of this invention can be installed into a digital IC recorder having recoding capability as well as a reproduction only player. It makes a voice recorder much more convenient than a conventional recorder. An IC recorder is very popular for usually using in a meeting or an interview to record voice. In those cases this type of recorder with this technique of this invention is very convenient at the time when it reproduces the recorded voice because a listener can repeat to reproduce a unit of vocal chunk when he/she can not catch clearly the voice.

Furthermore, due to the function of auto reproduction stop mode ON, it can make productivity of dictation dramatically high. With prior conventional technique, if reproduction is stopped by a listener, usually it stops at odd position of the pronunciation. Then, when a listener continues to reproduce a next zone, it starts from also odd position of pronunciation. So, it is hard to catch the pronunciation of its beginning. It frequently happens. Accordingly, most of listeners cannot but rewind a little to backward before starting reproduction of the next zone to catch its beginning part surely. Namely, listeners have to hear again what was reproduced once. It means they must waste much more time when this frequency gets high. In case, however, it is reproduced under auto reproduction mode, it is almost no need to rewind since it is reproduced with a unit of vocal chunk.

Moreover, it is not difficult to extend this technique to a system with motion picture synchronizing with vocal chunks. And, if the system based on this invention is installed to DVD player, network television or the like, the foreign movie can be an educational contents. Then, it helps many people learning foreign languages not only in Japan but also all over the world.

1. A voice reproduction method of reproducing a continuous digital audio data series including at least a voice data series, the method comprising the steps of:
converting the digital audio data series into one or more kinds of physical value data series each making it possible that vocal chunk boundaries of two or more vocal chunks included in the digital audio data series are judged using a threshold;
generating the threshold from a first physical value data series selected among the one or plural kinds of physical value data series;
memorizing location identifying information that indicates a most suitable location as a boundary address between the vocal chunks in a zone where a second physical value data series selected among the one or plural kinds of physical value data series is below the threshold; and
reproducing, while defining a reproduction starting point in the digital audio data series on the basis of the memorized local identifying information, the digital audio data series every one or more vocal chunk from the defined reproduction starting point, in accordance with a reproduction control signal generated from an arbitrarily instructed command.

2. A voice reproduction method according to claim 1, wherein the memorization step includes the steps of: extracting small amplitude zones contained in the digital audio data series; selecting, from the extracted small amplitude zones, a small amplitude zone sandwiched by two vocal chunks; and defining the boundary address between two vocal chunks in the selected small amplitude zone as the location identifying information.

3. A voice reproduction method according to claim 1, wherein the conversion step includes the steps of: generating, after dividing the digital audio data series corresponding to reproduced sound wave of the digital audio data series into frequency domains, one or more kinds of amplitude data series by extracting specific frequency components from the divided frequency domains; and generating a bottom line that connects minimum value points of a first amplitude data series selected from the generated one or plural kinds of amplitude data series,
wherein the generation step includes the step of setting a threshold is set in using the generated bottom line as a base level of the first amplitude data series, and
wherein the memorization step includes the steps of: selecting, as the small amplitude zone located among two or more vocal chunks included in the digital audio data series, a zone below the threshold for a specific time in a second amplitude data series selected from the generated one or plural kinds of amplitude data series; and memorizing, as the local identifying information, the boundary address located between the two vocal chunks sandwiching the selected small amplitude zone and in the selected small amplitude zone.

4. A voice reproduction method according to claim 3, wherein the bottom line is generated under the condition that time constant is set shorter during value of the first amplitude data series decreases due to time decay while time constant is set longer during the value increases due to time decay.

5. A voice reproduction method according to claim 3, wherein, as the threshold, a first threshold for detecting simply descending zone of the first amplitude data series is set, and a second threshold for detecting a simply successive upbeat zone of the first amplitude data series and is greater than the first threshold is set.

6. A voice reproduction method according to claim 1, wherein, in the selected small amplitude zone, a position with minimum value of reproduction amplitude is defined as the boundary address.

7. A voice reproduction method according to claim 3, wherein, in the selected small amplitude zone, a position having highest changing rate of frequency spectrum is defined as the boundary address.

8. A voice reproduction method according to claim 3, wherein a silent zone with a predetermined time is inserted at the boundary address of the second amplitude data series.

9. A voice reproduction method according to claim 1, wherein, the small amplitude zone with longer dwell time than a certain time length among the sequentially-selected small amplitude zones is identified as one vocal chunk, and both a starting point and an ending point of the small amplitude zone are identified as one vocal chunk, as the boundary addresses between the adjacent vocal chunks.

10. A computer program stored in a computer readable medium for letting a computer execute a voice reproduction method according to claim 1.

11. A recording medium in which a computer program for letting a computer execute a voice reproduction method according to claim 1.

12. A voice reproduction apparatus of reproducing a continuous digital audio data series including at least a voice data series, the apparatus comprising:
a vocal chunk extraction block: converting the digital audio data series into one or more kinds of physical value data series each making it possible that vocal chunk boundaries of two or more vocal chunks included in the digital audio data series are judged using a threshold;
generating the threshold from a first physical value data series selected among the one or plural kinds of physical value data series; and memorizing location identifying information that indicates a most suitable location as a boundary address between the vocal chunks in a zone where a second physical value data series selected among the one or plural kinds of physical value data series is below the threshold, wherein the vocal chunk extraction block: extracts small amplitude zones contained in the digital audio data series; selects, from the extracted small amplitude zones, a small amplitude zone sandwiched by two vocal chunks; and extracts the boundary address between two vocal chunks in the selected small amplitude zone as the location identifying information; and
an audio reproduction control block reproducing, while defining a reproduction starting point in the digital audio data series on the basis of the memorized local identifying information, the digital audio data series every one or more vocal chunk from the defined reproduction starting point, in accordance with a reproduction control signal generated from an arbitrarily instructed command.

13. A voice reproduction apparatus according to claim 12 wherein the vocal chunk extraction block: generating, after dividing the digital audio data series corresponding to reproduced sound wave of the digital audio data series into frequency domains, one or more kinds of amplitude data series by extracting specific frequency components from the divided frequency domains; generating a bottom line that connects minimum value points of a first amplitude data series selected from the generated one or plural kinds of amplitude data series; setting a threshold is set in using the generated bottom line as a base level of the first amplitude data series; selecting, as the small amplitude zone located among two or more vocal chunks included in the digital audio data series, a zone below the threshold for a specific time in a second amplitude data series selected from the generated one or plural kinds of amplitude data series; and memorizing, as the local identifying information, the boundary address located between the two vocal chunks sandwiching the selected small amplitude zone and in the selected small amplitude zone.

14. A voice reproduction apparatus according to claim 13, wherein the vocal chunk extraction block generates the bottom line under the condition that time constant is set shorter during value of the first amplitude data series decreases due to time decay while time constant is set longer during the value increases due to time decay.

15. A voice reproduction apparatus according to claim 13, wherein the vocal chunk extraction block sets, as the threshold, a first threshold which is a threshold for detecting simply descending zone of the first amplitude data series, and a second threshold which is a threshold for detecting a simply successive upbeat zone of the first amplitude data series and is greater than the first threshold.

16. A voice reproduction apparatus according to claim 12, wherein the vocal chunk extraction block defines, as the boundary address, a position with minimum value of reproduction amplitude, in the selected small amplitude zone is defined.

17. A voice reproduction apparatus according to claim 13, wherein the vocal chunk extraction block defines, as the boundary address, a position having highest changing rate of frequency spectrum, in the selected small amplitude zone.

18. A voice reproduction apparatus according to claim 13, wherein the vocal chunk extraction block inserts a silent zone with a predetermined time at the boundary address of the second amplitude data series.

19. A voice reproduction apparatus according to claim 12, wherein the vocal chunk extraction block: identifies, as one vocal chunk, the small amplitude zone with longer dwell time than a certain time length among the sequentially-selected small amplitude zones; and defines both a starting point and an ending point of the small amplitude zone, identified as one vocal chunk, as the boundary addresses between the adjacent vocal chunks.

20. A distribution system of distributing a digital audio data series including at least a vocal data series through a communication line, wherein
the system comprises a vocal chunk extraction block which converts the digital audio data series into one or more kinds of physical value data series each making it possible that vocal chunk boundaries of two or more vocal chunks included in the digital audio data series are judged using a threshold; generates the threshold from a first physical value data series selected among the one or plural kinds of physical value data series; and memorizes location identifying information that indicates a most suitable location as a boundary address between the vocal chunks in a zone where a second physical value data series selected among the one or plural kinds of physical value data series is below the threshold, the vocal chunk extraction block extracting small amplitude zones contained in the digital audio data series; selects, from the extracted small amplitude zones, a small amplitude zone sandwiched by two vocal chunks; and
extracting the boundary address between two vocal chunks in the selected small amplitude zone as the location identifying information, and the system distributes the digital audio data series together with a data series of the extracted location identifying information.

21. A distribution system according to claim 20, wherein the vocal chunk extraction block: generates, after dividing the digital audio data series corresponding to reproduced sound wave of the digital audio data series into frequency domains, one or more kinds of amplitude data series by extracting specific frequency components from the divided frequency domains; generates a bottom line that connects minimum value points of a first amplitude data series selected from the generated one or plural kinds of amplitude data series; sets a threshold is set in using the generated bottom line as a base level of the first amplitude data series; selects, as the small amplitude zone located among two or more vocal chunks included in the digital audio data series, a zone below the threshold for a specific time in a second amplitude data series selected from the generated one or plural kinds of amplitude data series; and memorizes, as the local identifying information, the boundary address located between the two vocal chunks sandwiching the selected small amplitude zone and in the selected small amplitude zone.

22. A distribution system according to claim 21, wherein the vocal chunk extraction block generates the bottom line under the condition that time constant is set shorter during value of the first amplitude data series decreases due to time decay while time constant is set longer during the value increases due to time decay.

23. A distribution system according to claim 21, wherein the vocal chunk extraction block sets, as the threshold, a first threshold which is a threshold for detecting simply descending zone of the first amplitude data series, and a second threshold which is a threshold for detecting a simply successive upbeat zone of the first amplitude data series and is greater than the first threshold.

24. A distribution system according to claim 20, wherein the vocal chunk extraction block defines, as the boundary address, a position with minimum value of reproduction amplitude, in the selected small amplitude zone is defined.

25. A distribution system according to claim 21, wherein the vocal chunk extraction block defines, as the boundary address, a position having highest changing rate of frequency spectrum, in the selected small amplitude zone.

26. A distribution system according to claim 21, wherein the vocal chunk extraction block inserts a silent zone with a predetermined time at the boundary address of the second amplitude data series.

27. A distribution system according to claim 20, wherein the vocal chunk extraction block: identifies, as one vocal chunk, the small amplitude zone with longer dwell time than a certain time length among the sequentially-selected small amplitude zones; and defines both a starting point and an ending point of the small amplitude zone, identified as one vocal chunk, as the boundary addresses between the adjacent vocal chunks.
